(19) United States
(12) Patent Application Publication
(10) Pub. No.: US 2007/0277142 A1
(43) Pub. Date: Nov. 29, 2007

(54) LSI design supporting apparatus and LSI design supporting program used for designing and manufacturing LSI

(75) Inventor: Takahide Ezaki, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/802,317

(22) Filed: May 22, 2007

(30) Foreign Application Priority Data
May 23, 2006 (JP) 2006-142860

(51) Int. Cl. G06F 17/50

(52) U.S. Cl. 716/18

(57) ABSTRACT

A computer program product for supporting an LSI design, embodied on a computer-readable medium and including code that, when executed, causes a computer to perform the following steps (a) to (c). The step (a) is a step of supplying parameters corresponding to a target to be created for an operation library used for behavioral synthesis in an LSI design. The step (b) is a step of creating a high-level operation unit composed of a plurality of operation units on the basis of the parameters, each of the plurality of operation units is available to be shared in a process of behavioral synthesis. The step (c) is a step of creating the operation library by using the high-level operation unit.

### BACKGROUND OF THE INVENTION

1. Field of the Invention

The present invention relates to an LSI design supporting apparatus and an LSI deign supporting program used for designing and manufacturing of an LSI (Large Scale Integrated circuit).

2. Description of Related Art

In recent years, LSIs have been installed in most of electronics devices on the market. In association with the advancement of a semiconductor technique, a lifecycle of the electronics device on the market becomes more and more short. Thus, for semiconductor manufacturers, it is important to develop a high performance system LSI in a short period.

As the technique that develops the system LSI in the short period, the technique of developing the system LSI is known which uses a behavioral synthesis tool. The behavioral synthesis tool is an EDA (Electronic Design Automation) tool for creating an RTL (Register Transfer Level) description from an algorithm that represents the operations of hardware. Here, the RTL description will be supplied to a logic synthesis tool.

As the method for reducing the development period of the system LSI when using the behavioral synthesis tool, for example, a software-hardware co-simulation is known. In the software-hardware co-simulation, a software-hardware co-simulator describes system specifications including a software part and a hardware part by using a language at an behavioral description level such as a C/C++ language, and executes the co-simulation at a system level. In the conventional development of the system LSI, the detailed design of each of the software and the hardware is executed after the execution of the software-hardware co-simulation.

When the hardware part is designed in detail, the technique is known which executes the behavioral synthesis by using the description (the description of the hardware part in the system specifications described by using the C/C++ language and the like) used in the software-hardware co-simulation. An example of the technique will be described with reference to attached drawings. Here, this technique is disclosed in a report in Nikkei Electronics, 1996, 2, 12 (No. 655), p146 to 169, Nikkei BP Corporation, “Development of Transmission LSI through Behavioral Synthesis, Period of Function Design Is Reduced to 1/10”.

FIG. 1 is a flowchart showing an LSI design process described in the above-mentioned paper. With reference to FIG. 1, the conventional behavioral synthesis uses the behavioral description as an input and prepares the RTL description. The above-mentioned paper discloses the technique with regard to the scheduling and allocation which are the main functions of the behavioral synthesis. The scheduling in the behavioral synthesis is the process for making the respective calculations, which are executed in the LSI targeted for the development, parallel and sequential on the basis of the behavioral description. In other words, based on the execution of the scheduling, it is determined which of calculations is executed, when it is executed, and when it has a turn being executed, at the time when the LSI is operated. Also, the allocation is the process for allocating each of the scheduled calculations to a operation unit. Moreover, in the conventional behavioral synthesis, the allocation is executed to share the operation unit.

In sharing the operation unit in the allocation, when a particular operator is known not to be used at the same time after the execution of the behavioral synthesis, it is determined that the operation unit is commonly used. This sharing enables the miniaturization of the entire circuit scale of the LSI to be developed.

As shown in FIG. 1, in the conventional behavioral synthesis, attention is paid to the calculation noted in the behavioral description, and the optimizing processes such as the scheduling and the sharing are executed. The operation units targeted for the scheduling and sharing in the conventional behavioral synthesis are contained in a operation (arithmetic) library.

FIG. 2 is a table showing information related to the operation units contained in an operation library. With reference to FIG. 2, the conventional operation library in the design process noted in the above-mentioned paper includes the basic operation units such as an adder, a subtractor and a multiplier, correspondingly to the bit number of arguments.

As mentioned above, the conventional operation library includes the basic operation units such as the adder, the subtractor and the multiplier. In association with the integration on larger scale and diversification of the system LSI targeted for the development, it is required that calculations are executed which use complex (or high-level) operation units such as a floating-point operation unit and a trigonometric function operation unit. In the conventional behavioral synthesis, such complex calculations are included in the operation library in units of a macro, an IP (intellectual property) or the like.

The conventional behavioral synthesis will be explained by exemplifying the case that the behavioral synthesis is performed on the behavioral description having the calculation that uses the floating point. As mentioned above, the operation unit (hereinafter, referred to as the floating-point operation unit) for executing the floating-point operation is prepared as the macro in the operation library. In this case, when the behavioral synthesis is executed, the scheduling and sharing are executed in units of the macro of this floating-point operation unit.

Also, the conventional behavioral synthesis will be explained by exemplifying the case that the behavioral synthesis is performed on the behavioral description having the calculation that uses the trigonometric function. In the calculation using the trigonometric function, the calculation result corresponding to the value of an argument is configured as a table, and it is directly represented by using a numeral. In this case, when the behavioral synthesis is executed for the behavioral description having the trigonometric function, each table is assigned to the calculation part of the trigonometric function. Thus, similarly to the floating-point operation unit, consequently, there are the limits to degrees of freedom of the scheduling and the sharing.

In this way, in the behavioral synthesis that uses the operation library having the macros of the complex operation units, when the scheduling and the sharing are executed, they are executed between the macros (or between IPs).

In this case, we have now discovered the following facts. In the behavioral synthesis of the system LSI, there is the case that the degrees of freedom of the scheduling and the sharing are limited. In the development of the system LSI, when the degrees of freedom of the scheduling and sharing in the behavioral synthesis are limited, there is the case that the optimal behavioral synthesis result cannot be obtained.

In short, conventionally, the system specifications described by using the C/C++ language and the like is used to define the behavioral description of the hardware part. However, depending on the describing manner of the system specifications described by using the C/C++ language and the like, there is the problem that the optimal behavioral synthesis result cannot be obtained due to the limit on the degrees of freedom as mentioned above.

### SUMMARY

In order to achieve an aspect of the present invention, the present invention provides a computer program product for supporting an LSI design, embodied on a computer-readable medium and including code that, when executed, causes a computer to perform the following: (a) supplying parameters corresponding to a target to be created for an operation library used for behavioral synthesis in an LSI design; (b) creating a high-level operation unit composed of a plurality of operation units on the basis of the parameters, each of the plurality of operation units is available to be shared in a process of behavioral synthesis; and (c) creating the operation library by using the high-level operation unit.

The operation library of the present invention includes the operation unit library (for example, a floating-point addition library and a SIN function library) corresponding to operation units for executing complex calculations such as floating-point operation and trigonometric function calculation. This operation unit library is configured by a combination of simple operation units that enable scheduling and sharing in behavioral synthesis. Thus, even if the behavioral description includes the foregoing complex calculations, there is no case that the scheduling and sharing of the operation units at the time of the behavioral synthesis are limited which reduces the degrees of freedom thereof. Also, when a C language and a C++ language or the like is used to describe a system specifications, the shift from that description to the behavioral description for hardware can be smoothly attained.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a flowchart showing a conventional LSI design process;

FIG. 2 is a table showing a configuration of a conventional operation library;

FIG. 3 is a block diagram showing an example of a configuration of an LSI design supporting apparatus according to the present invention;

FIG. 4 is a block diagram showing an example of a configuration of the data storage unit;

FIG. 5 is a block diagram showing an example of a configuration of a program storage unit;

FIG. 6 is a table showing an example of a configuration of a parameter storage unit;

FIG. 7 is a flowchart showing an example of an operation of the first embodiment;

FIG. 8 is a view showing an example of a configuration of a floating-point addition library in the first embodiment;

FIG. 9 is a graph exemplifying an operation in this embodiment;

FIG. 10 is a graph exemplifying the operation when the difference between SIN(x) and the linear approximation is approximated by using the quadratic equation;

FIG. 11 is a view showing an example of a configuration of the trigonometric function library in the first embodiment;

FIG. 12 is a flowchart showing an example of an operation in a second embodiment;

FIG. 13 is a list showing an example of the algorithm description for the hardware;

FIG. 14 is a list showing an example of the source of the link changing unit; and

FIG. 15 is a list showing an example of post-link-change description.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Embodiments of an LSI design supporting apparatus according to the present invention will be described below with reference to the attached drawings. Here, in the following embodiments, the description of a behavioral level (algorithm level) is referred to as an algorithm description. Also, the description of RTL is referred to as the RTL description. Also, the description of a gate level is referred to as a logic description. Thus, the expansion to the RTL description from the behavioral description is referred to as an behavioral synthesis, and the expansion to the gate level from the RTL description is referred to as a logic synthesis. Moreover, in the following embodiments, the present invention will be explained by exemplifying the case that the algorithm description is described by using the C/C++ language. This does not imply that the algorithm description applied to the present invention is limited to the C/C++ language.

### First Embodiment

### [Configuration]

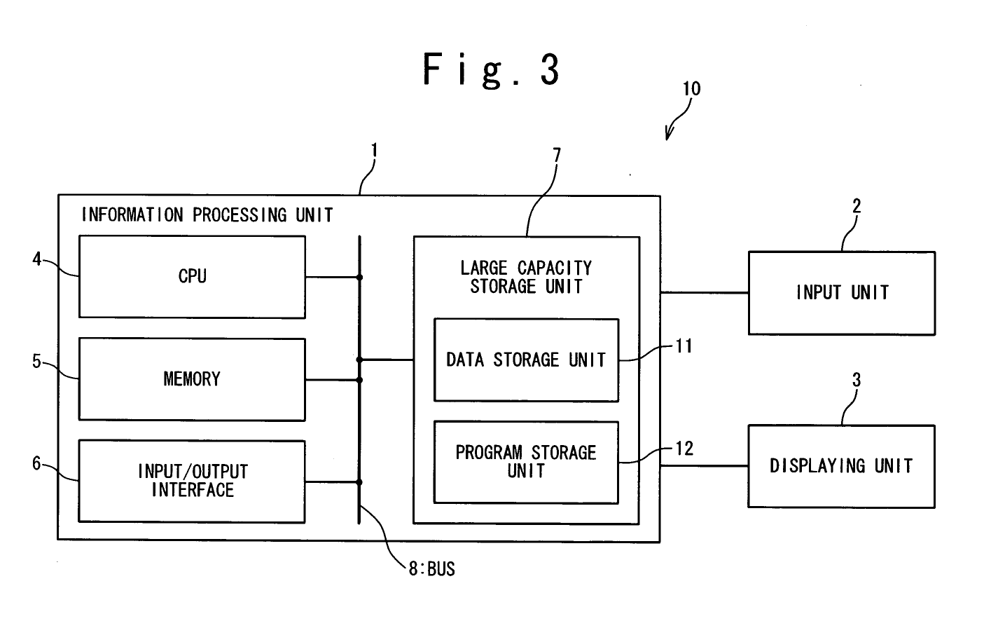

FIG. 3 is a block diagram showing an example of a configuration of an LSI design supporting apparatus according to the present invention. With reference to FIG. 3, the LSI design supporting apparatus 10 in this embodiment includes an information processing unit 1, an input unit 2 and a displaying unit 3. Also, by sending the information of the semiconductor device designed by the LSI design supporting apparatus 10 to a semiconductor manufacturing apparatus (not shown), the present invention can be applied to the semiconductor manufacturing.

The information processing unit 1 is the high speed operation processor represented by a personal computer, a work station and the like. The input unit 2 is the man-machine interface having a function for inputting a data to the information processing unit 1 and is represented by, for example, a keyboard, a mouse or the like. The following embodiment will be explained in an exemplary case that the input unit 2 is the keyboard. The displaying unit 3 is the man-machine interface having a function for outputting the process result of the information processing unit 1 to outside and is represented by CRT and a liquid crystal display. The following embodiment is explained in an exemplary case that the displaying unit 3 is a display apparatus where an extracted parameter value, a simulation result and the like are visually indicated.

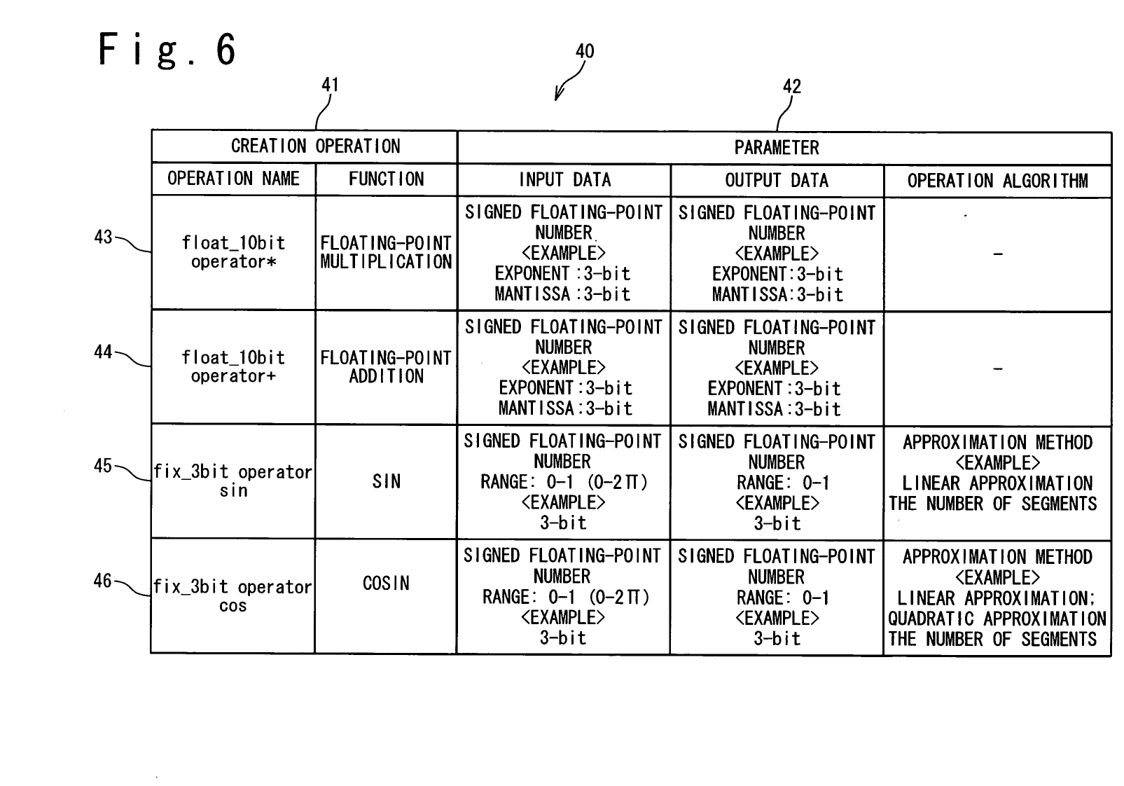

As shown in FIG. 3, the information processing unit 1 includes a CPU (Central Processing Unit) 4, a memory 5, an input/output interface 6 and a large capacity storage unit 7, and they are connected to each other through a bus 8. The CPU 4 is the operation processing unit for controlling the various units included in the LSI design supporting apparatus 10 and processing the data which is inputted to and outputted from the information processing unit 1. The CPU 4 interprets and calculates data received from the input unit 2 or the like and outputs calculation results to the displaying device 3 or the like. The memory 5 is the storage medium where the data can be written and read out, and can be exemplified as a SDRAM and DDR-SDRAM. The input/output interface 6 is the unit for controlling a data communication that is executed between the input unit 2, the displaying unit 3 and the information processing unit 1. The large capacity storage unit 7 is the unit that is used to record a large quantity of data in the storage medium, and can be exemplified as a HDD (Hard Disk Drive). Also, as shown in FIG. 6, the large capacity storage unit 7 is composed of a data storage unit 11 and a program storage unit 12.

The data storage unit 11 indicates the storage region that stores the data related to this embodiment, among the various data held by the large capacity storage unit 7. Also, similarly, the program storage unit 12 indicates the storage region that stores the computer program related to the operations in this embodiment, among the various data stored by the large capacity storage unit 7. The detailed configurations of the data storage unit 11 and the program storage unit 12 will be described below with reference to the drawings.

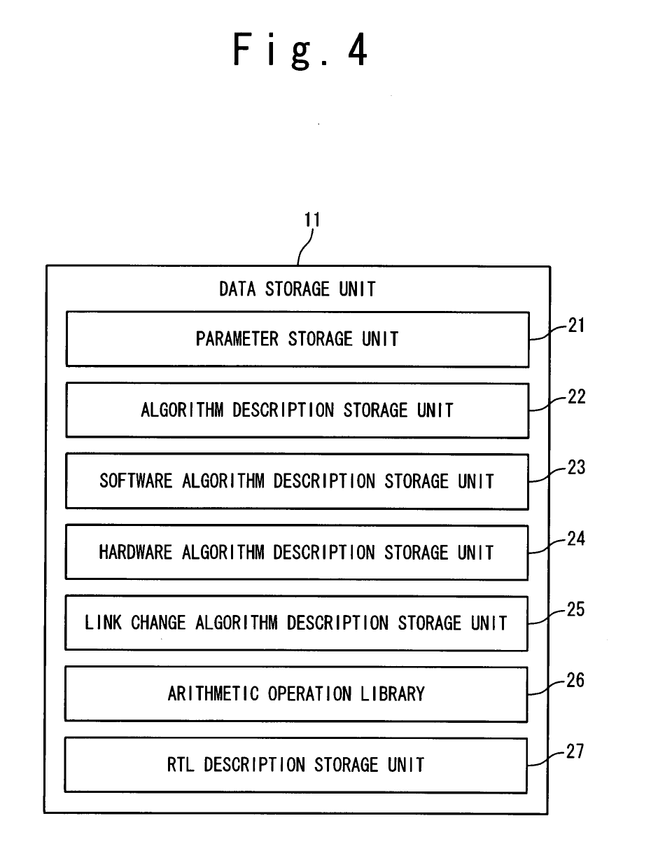

FIG. 4 is a block diagram showing an example of a configuration of the data storage unit 11. With reference to FIG. 4, the data storage unit 11 is composed of a parameter storage unit 21, an algorithm description storage unit 22, a software algorithm description storage unit 23, a hardware algorithm description storage unit 24, a link change algorithm description storage unit 25, an arithmetic operation library 26 and an RTL description storage unit 27.

The parameter storage unit 21 stores parameters inputted through the input unit 2. The hardware algorithm description storage unit 24 stores algorithm description based on the system specifications that is described by using the C language or C++ language. The software algorithm description storage unit 23 stores software algorithm description that describes a software part in the algorithm description. The hardware algorithm description storage unit 24 stores hardware algorithm description that describes a hardware part in the algorithm description. The link change algorithm description storage unit 25 stores post-link-change description where a link of the hardware algorithm description is changed. The arithmetic operation library 26 stores operation units used in the behavioral synthesis. The RTL description storage unit 27 stores RTL description generated by the behavioral synthesis. This RTL description is used in the logic synthesis.

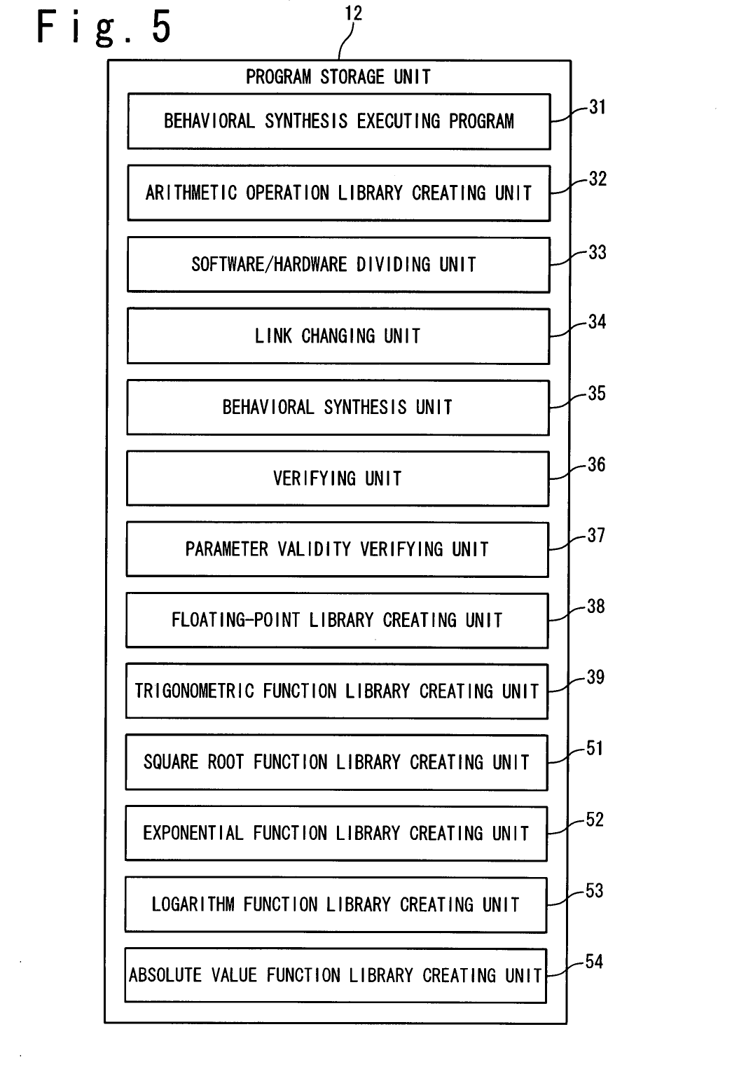

FIG. 5 is a block diagram showing an example of a configuration of the program storage unit 12. With reference to FIG. 5, the program storage unit 12 is composed of a behavioral synthesis executing program 31, a arithmetic operation library creating unit 32, a software/hardware dividing unit 33, a link changing unit 34, a behavioral synthesis unit 35, a verifying unit 36, a parameter validity verifying unit 37, a floating-point library creating unit 38 and a trigonometric function library creating unit 39.

The behavioral synthesis executing program 31 includes a procedure for creating RTL description from the behavioral description in this embodiment. The arithmetic operation library creating unit 32 includes a procedure for creating the operation units (complex operation unit library) to be stored in the arithmetic operation library 26. The software/hardware dividing unit 33 includes a procedure for specifying description of the software part and description of the hardware part, from the algorithm description in the system specifications. The link changing unit 34 includes a procedure for creating post-link-change description where a link of the hardware algorithm description is changed. The behavioral synthesis unit 35 includes a procedure for executing the behavioral synthesis in accordance with the post-link-change description. The verifying unit 36 includes a procedure for a verifying operation. The parameter validity verifying unit 37 includes a procedure for checking the validity of the input parameters, when the operation unit to be stored in the arithmetic operation library 26 is created. This parameter validity verifying unit 37 is read out correspondingly to the operation included in the arithmetic operation library creating unit 32. The floating-point library creating unit 38 includes a procedure for creating a floating-point library. The trigonometric function library creating unit 39 includes a procedure for creating a trigonometric library. Similarly, a square root function library creating unit 51, an exponential function library creating unit 52, a logarithm function library creating unit 53 and an absolute value function library creating unit 54 include procedures for creating a square root function library, an exponential function library, a logarithm function library and an absolute value function library, respectively.

FIG. 6 is a table showing an example of a configuration of the parameter storage unit 21. The parameters are specified on the basis of the operation unit to be created. For the created operation unit, a bit width, an algorithm and so on are determined correspondingly to a desirable operation precision, on the basis of the specified parameters. With reference to FIG. 6, on the parameter table 40, each creation operation 41 are correlated with parameter data 42. Also, the parameter table 40 exemplified in FIG. 6 includes the parameters with regard to a floating-point multiplication 43, a floating-point addition 44, an SIN function 45 and a COS function 46.

### [Operation]

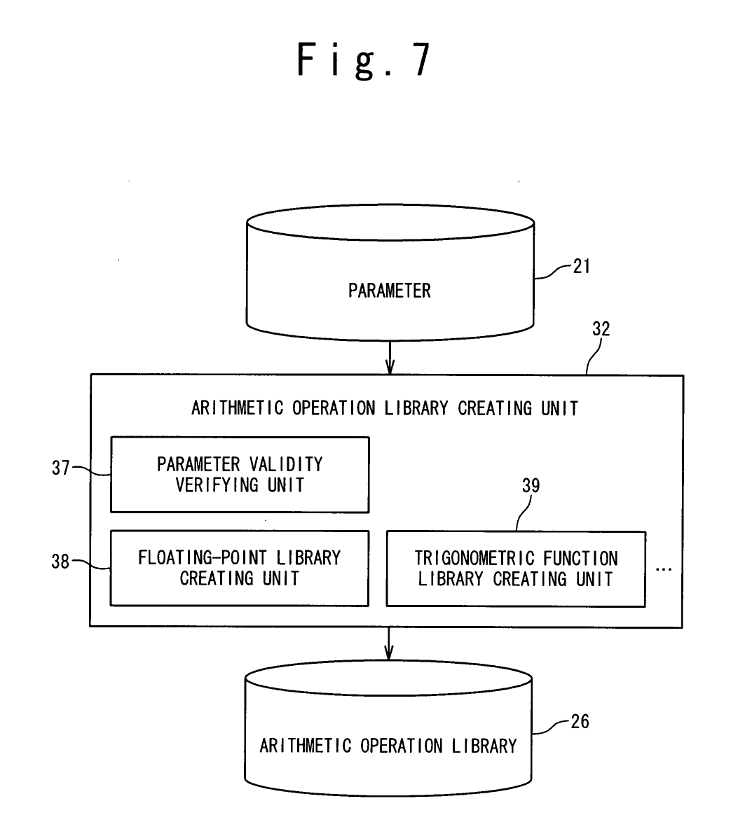

An operation of the first embodiment according to the present invention will be described below with reference to the drawings. FIG. 7 is a flowchart showing an example of an operation of the first embodiment in the LSI design supporting apparatus 10 according to the present invention. The information processing unit 1 in the first embodiment creates the arithmetic operation library 26, according to the procedure indicated in the arithmetic operation library creating unit 32. With reference to FIG. 7, the arithmetic operation library creating unit 32 reads out the parameter validity verifying unit 37, in response to inputted parameters. This checks the validity of the inputted parameters, according to the procedure indicated in the parameter validity verifying unit 37.

The LSI design supporting apparatus 10 determines whether or not a check for validity of the inputted parameters is executed, on the basis of the procedure indicated in the parameter validity verifying unit 37. If the check for the validity is determined to be executed, the check for the inputted parameters is executed. At this time, the LSI design supporting apparatus 10 outputs an error if invalid parameters are inputted on the basis of the procedure indicated in the parameter validity verifying unit 37. Also, the LSI design supporting apparatus 10 may be designed to request specifiable new parameters if the invalid parameters are inputted, based on the inputted parameters. If the inputted parameters are valid, the operation library creating units (38, 39) to be prepared are read out on the basis of the procedure indicated in the arithmetic operation library creating unit 32.

Hereinafter, the operation of the first embodiment will be explained regarding the case of a preparation for the operation library of a floating-point addition. The operation library of the floating-point addition is referred to as a floating-point addition library. Here, the arithmetic operation library creating unit 32 reads out the floating-point library creating unit 38 without executing the check for the validity by the parameter validity verifying unit 37, if the inputted parameters correspond to the floating-point addition library.

With reference to FIG. 7, the LSI design supporting apparatus 10 reads out the floating-point library creating unit 38, on the basis of the procedure indicated in the arithmetic operation library creating unit 32, in response to parameters 13 inputted from the input unit 2. The LSI design supporting apparatus 10 creates the floating-point addition library, on the basis of the procedure indicated in the floating-point library creating unit 38. As indicated on the parameter table 40 in FIG. 6, the parameters, which are used when the floating-point addition library is created, are a bit width of an exponent part and a bit width of a mantissa part in the input data, and a bit width of an exponent part and a bit width of a mantissa part in the output data.

Thus, The LSI design supporting apparatus 10 creates the floating-point addition library for executing the following process, on the basis of the procedure indicated in the floating-point library creating unit 38. The process of the floating-point addition library compares the exponent parts of the two arguments. Based on result obtained from the comparison, the smaller mantissa part is shifted so as to agree with the other mantissa part. After that, the shifted mantissa parts are added. Moreover, the addition result is normalized. In this normalization, the mantissa part is right-shifted or left-shifted to be converted into “1.m” (m is an integer) that represents the floating-point expression. Then, the normalized result is outputted as the result of the floating-point.

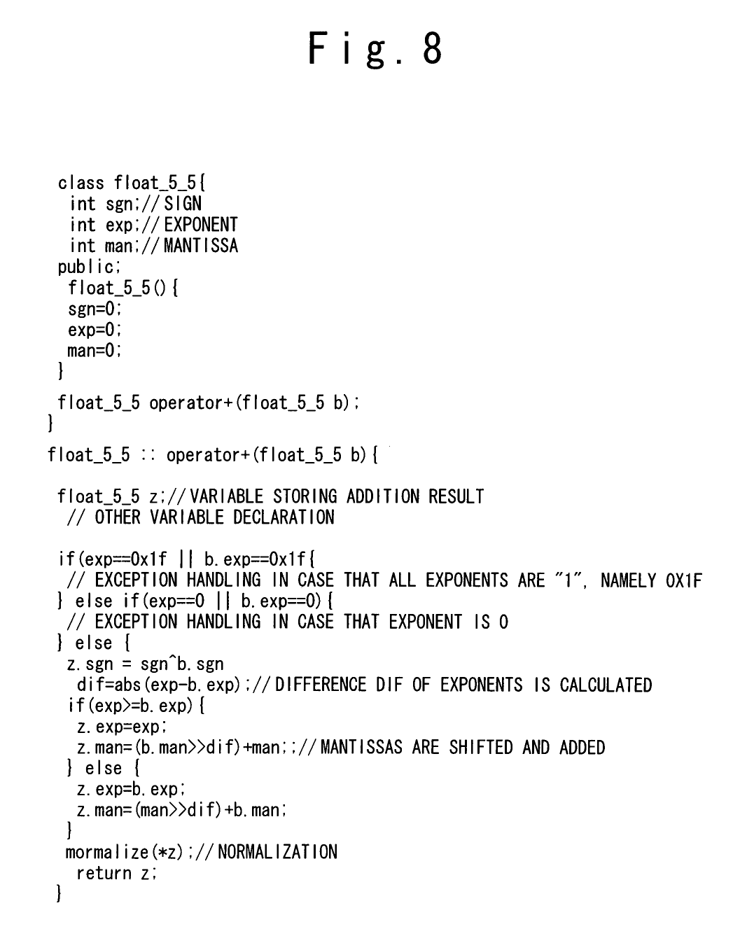

FIG. 8 is a view showing an example of a configuration of the floating-point addition library in this embodiment. With reference to FIG. 8, the floating-point addition library in this embodiment is created by the input of the parameters where the exponent part of the input data and output data is 5 bits and the mantissa part thereof is 5 bits. FIG. 8 shows that in the floating-point addition library in this embodiment, after declaration statements for variables and the like, the actual floating-point addition operation is composed of simple bit operations such as the shift (<<), the comparison (==, >=), the addition (+), the subtraction (−) and the like. As mentioned above, those simple bit operations are prepared in advance as the operation library for the behavioral synthesis.

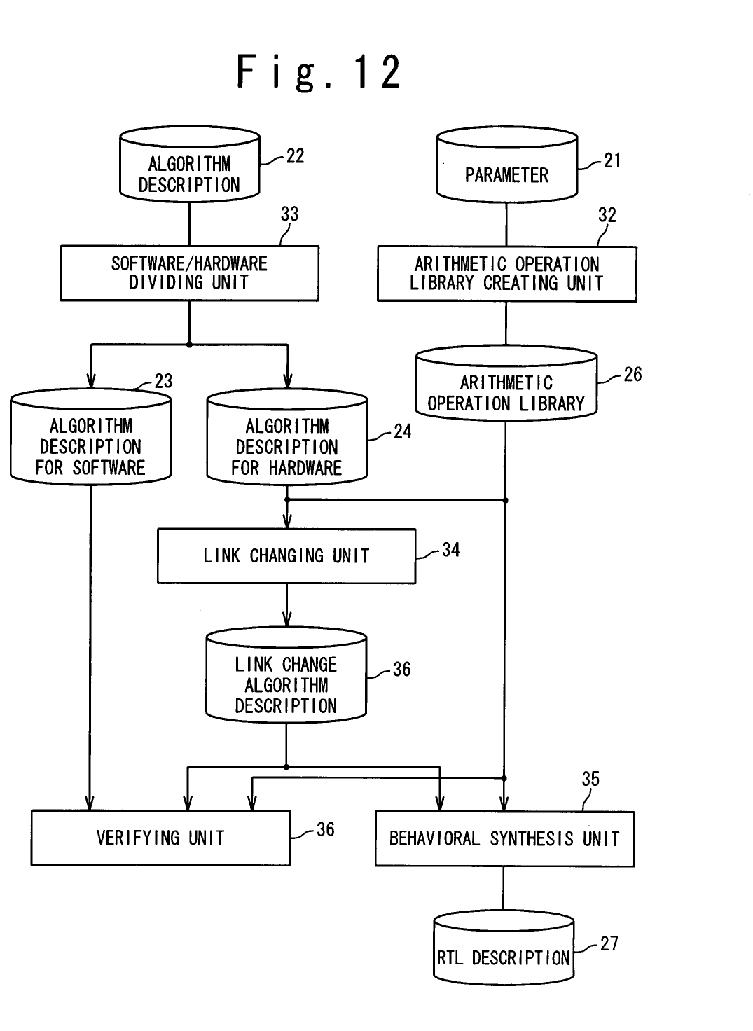

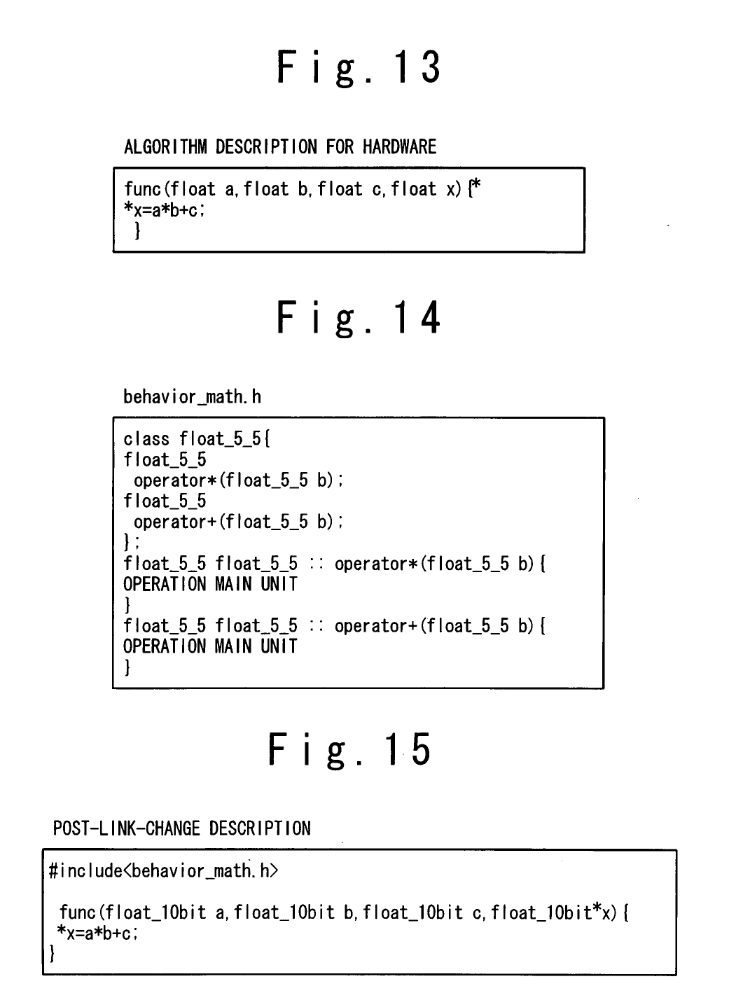

Here, the floating-point addition library in this embodiment will be specifically explained by exemplifying the case that the hardware algorithm description targeted for the execution of the behavioral synthesis is the description illustrated in FIG. 13, which will be explained later. In this case, the operation of “b+c” where the floating-point addition is attained by the shifter, comparator, adder and subtractor, which are prepared for the behavioral synthesis, using this floating-point addition library (Incidentally, the detail of a method for using the prepared library will be explained later).

Those shifter, comparator, adder and subtractor are targeted for the scheduling and sharing in the behavioral synthesis. In short, in the hardware algorithm description, when a portion other than the operation of “b+c” has the description of using the shifter, comparator, adder and subtractor, they may be targeted for the sharing of the operation unit in the behavioral synthesis.

Thus, due to the applying of the floating-point addition library in this embodiment, even if the behavioral description has the description of executing the floating-point addition, there is no case that the scheduling and sharing of the operation units at the time of the behavioral synthesis are limited which reduces the degrees of freedom. Specifically, the shifter and adder that are used in the floating-point addition library can be shared with the shifter and adder in the operations except the floating-point addition.

Incidentally, other than the operation for executing the floating-point addition, the operation in this embodiment can be applied to the floating-point subtraction and the floating-point multiplication. For example, in the case of the floating-point multiplication, the exponent part is added, and the mantissa part is multiplied. Then, the normalization based thereon enables the configuration of the floating-point addition library.

Hereinafter, the operation of the first embodiment will be explained regarding the case of a preparation for the operation library of a trigonometric function. The operation library of the trigonometric function is referred to as a trigonometric function library. As shown in the parameter table 40 of FIG. 6, the parameters used in creating the trigonometric function library are the bit width of the input data, the bit width of the output data, the approximation method, and the number of segments. The approximation method and the number of segments are the parameters having influence on the operation precision. Those parameters are specified on the basis of a desirable operation precision.

As mentioned above, with reference to FIG. 7, the LSI design supporting apparatus 10 in this embodiment reads out the parameter validity verifying unit 37, in accordance with the procedure indicated in the arithmetic operation library creating unit 32, in response to the parameter inputted from the input unit 2. The LSI design supporting apparatus 10 determines whether or not the check for the validity of the inputted parameter 13 is executed, on the basis of the procedure indicated in the parameter validity verifying unit 37. Here, the parameter validity verifying unit 37 executes the check for the validity, in response to the inputs of the bit width of the exponent part in the input data, the bit width of the exponent part in the output data, the approximation method, and the number of segments. As mentioned above, when the invalid parameter 13 is inputted, the error (or the request of the specifiable new parameter) is outputted.

For example, the parameter validity verifying unit 37, when creating the trigonometric function library, uses an interpolation function of a linear or quadratic expression in accordance with the number of segments and then determines the operation result. At this time, the parameter validity verifying unit 37 determines whether or not the certain relation is satisfied. The certain relation is that an allowable range of the input data is equal to or larger than the number of segments.

Hereinafter, the validity check executed by the parameter validity verifying unit 37 will be specifically explained by exemplifying the case that the trigonometric function library to be created is a following equation (1).

y=sin(xπ/2):0≦x<1 (1)

In the equation (1) , the x indicates the input data. When the input data is assumed to be 3 bits, the allowable range of the x is as follows.
000:(0)
001
010:(π/8)
011
100:(π/4)
101
110:(3π/8)
111

### Thus, the maximum value of the number of segments in this case is 8 (eight).

Here, if the number of segments inputted as the parameter exceeds 8, the parameter validity verifying unit 37 outputs the error (or requests the specifiable parameter of 8 or less). Incidentally, if the numeral less than 8 is specified as the number of segments, the library is normally created. However, the operation precision of the library created at this case is decreased in comparison with the case when 8 is specified as the number of segments. Thus, since this number of segments is inputted in accordance with the necessary operation precision, the suitable library can be configured.

Also, other than this, when there are the limits on the bit widths of the input data and the output data and the number of segments on the basis of an area to be occupied by an actual hardware, it is checked whether or not those limits are satisfied.

After the completion of the check for the validity, the trigonometric function library creating unit 39 is read out in accordance with the procedure indicated in the arithmetic operation library creating unit 32. Here, the operation of the first embodiment will be explained by exemplifying the case that the procedure indicated in the read trigonometric function library creating unit 39 creates the operation unit of the SIN function. In the following embodiment, in order to easily understand the present invention, this will be explained by exemplifying the SIN function represented as a following equation.

y=sin(xπ/2):0≦x<1

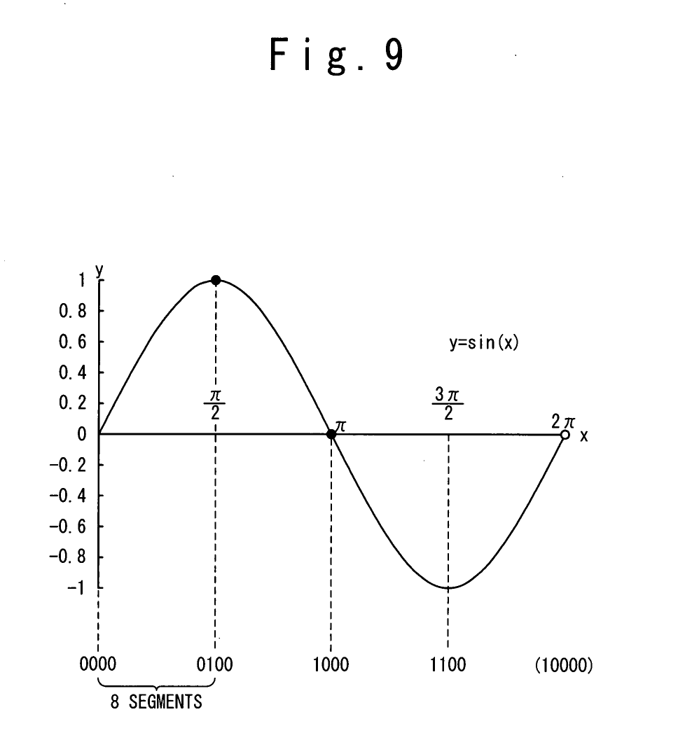

When the trigonometric function library is created, the allowable range of the function is firstly segmented by a predetermined constant. Then, the value at each segment point is used to execute the interpolation approximation. Consequently, the trigonometric function library can be created. FIG. 9 is a graph exemplifying the operation in this embodiment when the number of segments is 4 (four). As mentioned above, this number of segments is one of the parameters to create the trigonometric function library.

The interpolation approximation uses the value at the segment point and carries out the interpolation by using the linear equation. Also, this interpolation approximation may use the quadratic equation. Which of the linear equation and the quadratic equation is selected is determined on the basis of the input parameter.

The case of executing the interpolation approximation by using the linear equation will be described below. In the case of the linear equation approximation (straight approximation), the operation result is determined by a following equation (2).

y(x)=y(n)+{y(n+1)−y(n)}t (2)

Here,

t={x−x(n)}/(1/N)

N: the number of segments

n: any of segment points

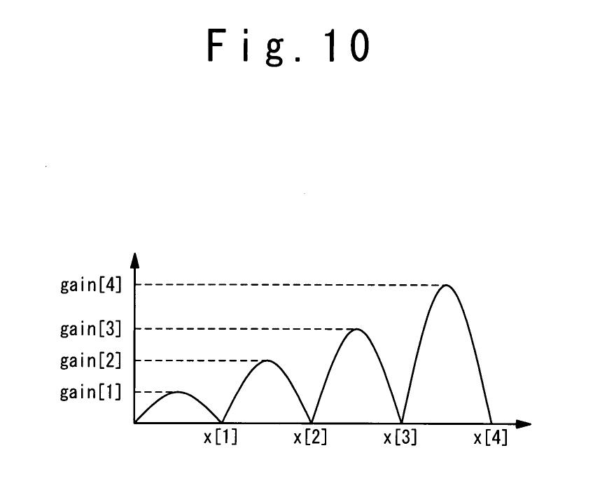

Also, the case of executing the interpolation approximation by using the quadratic equation will be described below. FIG. 10 is a graph exemplifying the operation when the difference between SIN (x) and the linear approximation is approximated by using the quadratic equation. In the case of the quadratic equation approximation, the operation result whose precision is higher than that of the linear equation approximation can be obtained. The operation result is obtained by a following equation (3).

y(x)=y(n)+{y(n+1)−y(n)}t+4t(1−t)gain(n) (3)

The trigonometric function library creating unit 39 creates the trigonometric function library having the foregoing process content, in accordance with the parameter storage unit 21 inputted through the input unit 2.

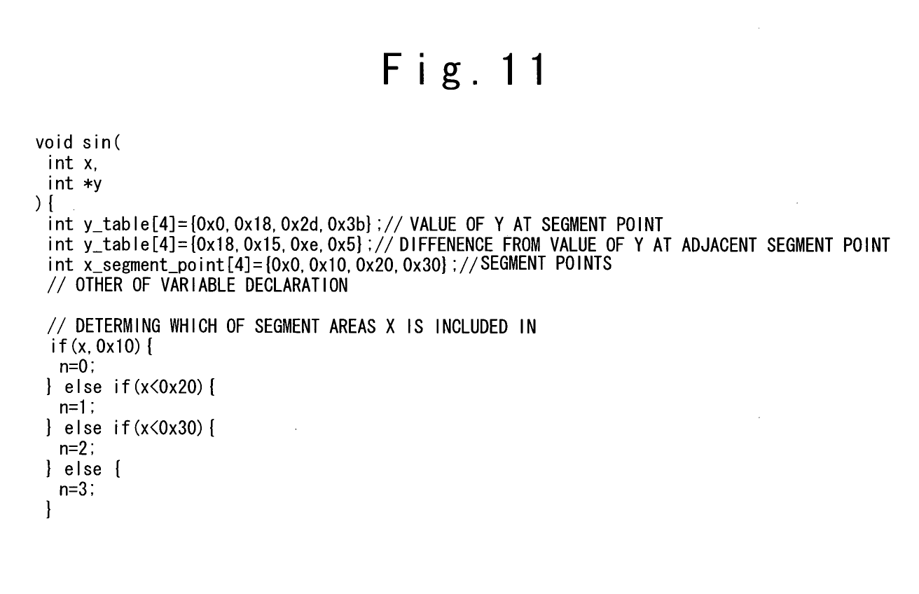

FIG. 11 is a view showing an example of a configuration of the trigonometric function library in this embodiment. FIG. 11 exemplifies the SIN function library as the trigonometric function library in this embodiment. The SIN function library is created such that the input data and output data have 8 bits and “the quadratic approximation” and “4” of the number of segments are inputted as the parameters for the operation algorithm. FIG. 11 shows that the actual SIN function operation in this SIN function library, after the declaration statements such as the variable and the like, are constituted by the simple comparison (<) , subtraction (−) , multiplication (*), shift (>>), addition (+) and the like.

Thus, similarly to the floating-point addition library, if there are the description of executing the SIN function operation and the description of executing another operation that uses the comparator, the subtractor, the multiplier, the shifter and the adder, they can be targeted for the sharing in the behavioral synthesis.

Thus, due to the applying of the trigonometric function library in this embodiment, even if the behavioral description has the description of executing the trigonometric function operation, there is no case that the scheduling and sharing of the operation units at the time of the behavioral synthesis are limited which reduces the degrees of freedom thereof. Specifically, the shifter and adder that are used in the trigonometric function library can be shared with the shifter and adder in the operations except the trigonometric function operation. Incidentally, the operations in this embodiment can be applied to the trigonometric function operation (for example, the COS operation) other than the operation that executes the trigonometric function (SIN function). Also, the explanation has been done by exemplifying the case of applying the linear equation and the quadratic equation as the approximation method. Other than this, for example, the approximation equation that uses the multiplication, shift and addition, which are the operations in units of a bit, can be applied.

As mentioned above, the operation library in this embodiment contains the operation unit library (for example, the floating-point addition library and the SIN function library) corresponding to the operation unit that executes the complex operation such as the floating point, the trigonometric function and the like. This operation unit library is configured by the combination of the simple operation units where the scheduling and sharing in the behavioral synthesis can be attained. Thus, even if the operation description includes the foregoing complex operations, there is no case that the scheduling and sharing of the operation units at the time of the behavioral synthesis are limited which reduces the degrees of freedom thereof. Also, when the C language, the C++ language or the like is used to describe the system specifications, the transition from the description to the operation description for the hardware can be smoothly attained.

### Second Embodiment

The second embodiment in the LSI design supporting apparatus of the present invention will be described below with reference to the drawings. The first embodiment has been explained with regard to the embodiment for creating the arithmetic operation library 26. The second embodiment will be explained with regard to a configuration and an operation to create the RTL description by using the arithmetic operation library 26.

FIG. 12 is a flowchart showing an example of an operation in this embodiment. With reference to FIG. 12, the LSI design supporting apparatus 10 in the second embodiment reads out the algorithm description stored in the algorithm description storage unit 22, on the basis of the procedure indicated in the behavioral synthesis executing program 31. The software/hardware dividing unit 33 specifies the algorithm description for the hardware in the read algorithm description. The software/hardware dividing unit 33 stores the specified algorithm description for the hardware in the hardware algorithm description storage unit 24. The link changing unit 34 reads out the algorithm description for the hardware stored in the hardware algorithm description storage unit 24 and the operation unit stored in the arithmetic operation library 26.

The link changing unit 34 changes the operation used in the algorithm description for the hardware such that the operation unit stored in the arithmetic operation library 26 can be used. The link changing unit 34 stores the changed result in the link change algorithm description storage unit 25 as the post-link-change description.

The behavioral synthesis unit 35 carries out the behavioral synthesis in accordance with the post-link-change description stores in the link change algorithm description storage unit 25 and the operation unit in the arithmetic operation library 26 and creates the RTL description.

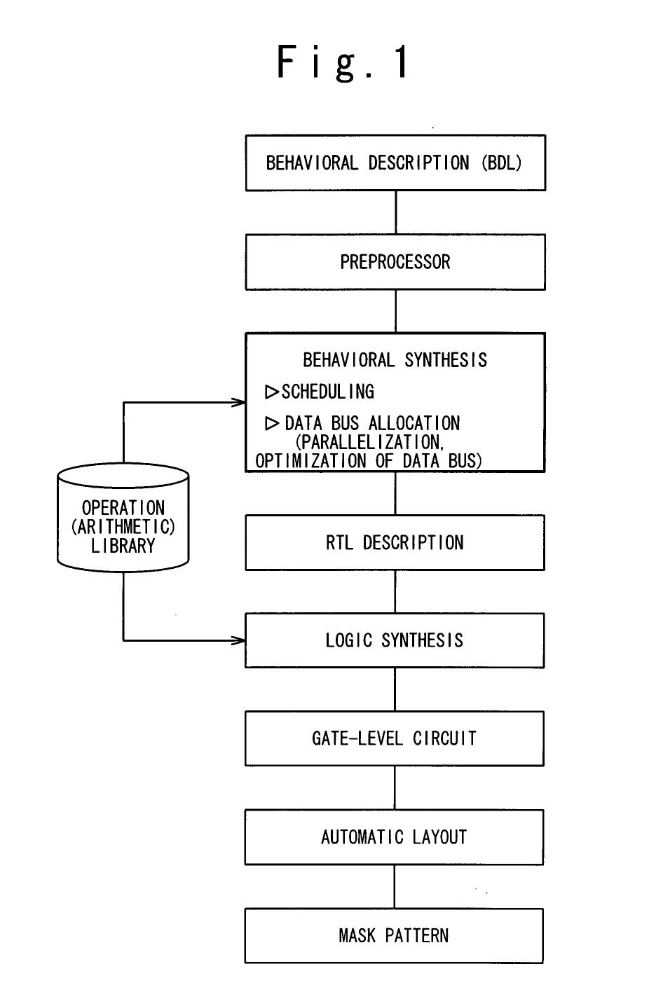

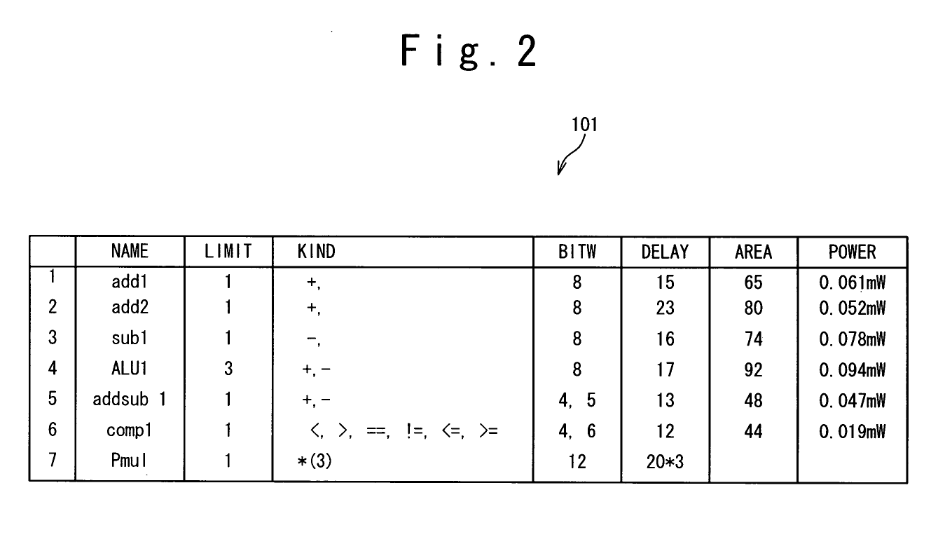

After obtaining the RTL description, the remaining LSI design process is performed as shown in FIG. 1. That is, the RTL description is inputted into the logic synthesis tool, and the logic synthesis is executed to obtain the gate-level circuits. Then, the automatic layout of the LSI is carried out based on the gate-level circuits. After that, the mask patterns is obtained according to the layout of the designed LSI. Finally, a semiconductor device is produced by using the obtained mask patterns.

The operations of the second embodiment will be described below by using the specific lists. FIG. 13 is a list showing an example of the algorithm description for the hardware, which is stored in the hardware algorithm description storage unit 24. The list shown in FIG. 13 is an example of a description that is extracted as the hardware part from the algorithm of the design target described by using the C++ language.

FIG. 14 is a floating-point operation unit library created by the operations in the first embodiment. The floating-point operation unit library includes the floating-point operation units which executes the floating-point multiplication and the floating-point addition. The library shown in FIG. 14 indicates the floating point composed of the exponent part of 5 bits and the mantissa part of 5 bits. The following embodiment will be explained by exemplifying the case that the design specifications when it is made into hardware is the design specifications composed of the exponent part of 5 bits and the mantissa part of 5 bits. Usually, the floating point of the C++ language is defined as 32 bits or 64 bits. In the case of the design specifications, when the floating-point operation unit library of 32 bits or 64 bits is configured in its original state, this results in the configuration of a redundant hardware.

FIG. 15 is a list indicating an example of the post-link-change description created by the link changing unit 34. With reference to FIG. 15, a link declaration statement linking to the floating-point operation library in FIG. 14 is added to the post-link-change description indicated in the list. Also, the link changing unit 34 changes the declaration statement of the floating-point variables (a, b, c) in the list of FIG. 13 to float_5_5 in the list of FIG. 14 such that the calculation (*x=a* b+c) of the floating-point variables (a, b, c) used in the algorithm description for the hardware shown in FIG. 13 becomes the operation of the floating point in the created floating-point operation library.

Consequently, the created post-link-change description is passed to the behavioral synthesis unit 35. The behavioral synthesis unit 35 creates the RTL description on the basis of the post-link-change description and the operation unit stored in the arithmetic operation library 26. Incidentally, the above-mentioned embodiments use the overload function of the function that is supported by the C language/C++ language or the like. For this reason, by only changing the declaration statement of the variable, it is possible to replace the operations. Tentatively, if the algorithm description is configured by the language that does not support the overload function, by replacing the operation in accordance with the instruction from outside, it is possible to replace the operations in this embodiment.

It is apparent that the present invention is not limited to the above embodiments, but may be modified and changed without departing from the scope and spirit of the invention.

What is claimed is:

1. A computer program product for supporting an LSI design, embodied on a computer-readable medium and comprising code that, when executed, causes a computer to perform the following:
(a) supplying parameters corresponding to a target to be created for an operation library used for behavioral synthesis in an LSI design;
(b) creating a high-level operation unit composed of a plurality of operation units on the basis of said parameters, each of said plurality of operation units is available to be shared in a process of behavioral synthesis; and
(c) creating said operation library by using said high-level operation unit.

2. The computer program product according to claim 1, wherein said step (b) includes:
(b1) preparing said plurality of operation units such that said each of the plurality of operation units is available to be shared with another operation unit in said process of the behavioral synthesis.

3. The computer program product according to claim 1, wherein said step (b) includes:
(b2) checking a validity of said parameters in response to said supply of said parameters.

4. The computer program product according to claim 1, wherein said step (b) includes:
(b3) creating said high-level operation unit such that an operation executed by said high-level operation unit is a specified operation not to be shared with said each of the plurality of operation units and another operation unit in said process of the behavioral synthesis.

5. The computer program product according to claim 1, wherein said high-level operation unit is one of an operation unit executing a floating-point operation and an operation unit executing a trigonometric function operation.

6. The computer program product according to claim 1, further comprising:
(d) reading out algorithm description for hardware and said operation library; and
(e) specifying a high-level operation unit description corresponding to said high-level operation unit on the basis of said algorithm description for hardware, and changing said high-level operation unit description to said high-level operation unit in said operation library.

7. The computer program product according to claim 6, wherein said step (b) includes:
(b1) preparing said plurality of operation units such that said each of the plurality of operation units is available to be shared with another operation unit in said process of the behavioral synthesis, and
(b2) creating said high-level operation unit such that an operation executed by said high-level operation unit is a specified operation not to be shared with said each of the plurality of operation units and another operation unit in said process of the behavioral synthesis,
wherein said step (e) includes:
(e1) changing said high-level operation unit description in order to link said high-level operation unit description to said high-level operation unit in said operation library.

8. The computer program product according to claim 6, further comprising:
(f) creating a RTL circuit by executing behavioral synthesis on the basis of said operation library and said algorithm description for hardware changed to said high-level operation unit in said operation library.

9. An LSI design supporting apparatus comprising:
a parameter storage unit configured to store parameters corresponding to a target to be created for an operation library used for behavioral synthesis in an LSI design;
an operation library creating unit configured to read out said parameters from said parameter storage unit, and creating a high-level operation unit composed of a plurality of operation units on the basis of said parameters, each of said plurality of operation units is available to be shared in a process of behavioral synthesis; and
said operation library configured to store said high-level operation unit created by said operation library creating unit.

10. The LSI design supporting apparatus according to claim 9, wherein said operation library creating unit prepares said plurality of operation units such that said each of the plurality of operation units is available to be shared with another operation unit in said process of the behavioral synthesis.

11. The LSI design supporting apparatus according to claim 9, wherein said operation library creating unit includes:
a validity verifying unit configured to check a validity of said parameters in response to said read parameters.

12. The LSI design supporting apparatus according to claim 9, wherein said operation library creating unit creates said high-level operation unit such that an operation executed by said high-level operation unit is a specified operation not to be shared with said each of the plurality of operation units and another operation unit in said process of the behavioral synthesis.

13. The LSI design supporting apparatus according to claim 9, wherein said high-level operation unit is one of an operation unit executing a floating-point operation and an operation unit executing a trigonometric function operation.

14. The LSI design supporting apparatus according to claim 9, further comprising:
an algorithm storage unit configured to store algorithm description for hardware; and
a link changing unit configured to specify a high-level operation unit description corresponding to said high-level operation unit on the basis of said algorithm description for hardware, and change said high-level operation unit description to said high-level operation unit in said operation library.

15. The LSI design supporting apparatus according to claim 14, wherein said operation library creating unit prepares said plurality of operation units such that said each of the plurality of operation units is available to be shared with another operation unit in said process of the behavioral synthesis, and creates said high-level operation unit such that an operation executed by said high-level operation unit is a specified operation not to be shared with said each of the plurality of operation units and another operation unit in said process of the behavioral synthesis,
wherein said link changing unit changes said high-level operation unit description in order to link said high-level operation unit description to said high-level operation unit in said operation library.

16. The computer program product according to claim 14, further comprising:
a behavioral synthesis unit configured to create a RTL circuit by executing behavioral synthesis on the basis of said operation library and said algorithm description for hardware changed to said high-level operation unit in said operation library.
